(19) United States
(12) Patent Application Publication
(10) Pub. No.: US 2025/0338059 A1
(43) Pub. Date: Oct. 30, 2025

(54) SPEAKERS

(71) Applicant: SHENZHEN SHOKZ CO., LTD., Shenzhen (CN)

(72) Inventors: Wenbing ZHOU, Shenzhen (CN); Fengyun LIAO, Shenzhen (CN); Xin QI, Shenzhen (CN)

(73) Assignee: SHENZHEN SHOKZ CO., LTD., Shenzhen (CN)

(21) Appl. No.: 19/260,253

(22) Filed: Jul. 3, 2025

Related U.S. Application Data
(63) Continuation of application No. PCT/CN2023/107251, filed on Jul. 13, 2023.

(51) Int. Cl. H04R 1/22; H04R 1/02; H04R 1/06; H04R 1/10; H04R 1/26; H04R 1/40; H04R 17/00

(52) U.S. Cl. CPC H04R 1/227; H04R 1/025; H04R 1/06; H04R 1/1075; H04R 1/26; H04R 1/403; H04R 17/005; H04R 2460/13

(57) ABSTRACT

A speaker (100) is provided, including: a plurality of sound generation units (110) spaced apart along a first direction, the plurality of sound generation units being configured to vibrate in the first direction; a housing (120) configured to accommodate and support the plurality of sound generation units (110), the housing (120) being disposed with a plurality of sound outlet holes (121), and the housing (120) encloses a plurality of acoustic cavities (122) with the plurality of sound generation units (110), each of the plurality of acoustic cavities (122) being acoustically coupled to at least one sound outlet hole (121) on the housing (120). Under an excitation signal, two adjacent sound generation units, which are among the plurality of sound generation units (110) and share at least one acoustic cavity (122) in the plurality of acoustic cavities (122), vibrate in opposite directions in at least some low-frequency bands.

### CROSS-REFERENCE TO RELATED APPLICATION

This application is a continuation of International Application No. PCT/CN2023/107251, filed on Jul. 13, 2023, the contents of which are incorporated herein by reference.

### TECHNICAL FIELD

The present disclosure relates to the field of acoustic technology, and in particular to a speaker.

### BACKGROUND

Current consumer electronics products, including open binaural earphones, audio glasses, true wireless stereo (TWS) earphones, etc., progressively increases requirements for an output sound pressure level in the low-frequency band. If the existing air conduction electromagnetic speakers need to output a sufficient output sound pressure level at the low frequency, a large motion stroke and a large thickness size are required, which poses a greater challenge to a product size. Therefore, it is desirable to provide a speaker with a reasonable size, adjustable based on actual needs, and with a sufficient low-frequency output sound pressure level.

### SUMMARY

Embodiments of the present disclosure provide a speaker including: a plurality of sound generation units spaced apart along a first direction, the plurality of sound generation units being configured to vibrate in the first direction; a housing configured to accommodate and support the plurality of sound generation units, the housing being disposed with a plurality of sound outlet holes, and the housing encloses a plurality of acoustic cavities with the plurality of sound generation units, each of the plurality of acoustic cavities being acoustically coupled to at least one sound outlet hole on the housing. Under an excitation signal, two adjacent sound generation units, which are among the plurality of sound generation units and sharing at least one acoustic cavity in the plurality of acoustic cavities, vibrate in opposite directions in at least some low-frequency bands

In some embodiments, the housing includes a plurality of fixing rings, each fixing ring of the plurality of fixing rings fixing one sound generation unit of the plurality of sound generation units, and two acoustic outlet holes are disposed on a periphery of the fixing ring. The two acoustic outlet holes are respectively coupled to the acoustic cavities at two opposite sides of the sound generation unit.

In some embodiments, the housing includes a front housing and a rear housing, the front housing and its adjacent sound generation unit form a first acoustic cavity, the rear housing and its adjacent sound generation unit form a second acoustic cavity, a third acoustic cavity is formed between two adjacent sound generation units, and a thickness of the first acoustic cavity and/or a thickness of the second acoustic cavity in the first direction is less than a thickness of the third acoustic cavity in the first direction.

In some embodiments, heights of the first acoustic cavity and the second acoustic cavity in the first direction are greater than or equal to 150 um, a height of the third acoustic cavity in the first direction is greater than or equal to 300 um, heights of the sound outlet holes corresponding to the first acoustic cavity and the second acoustic cavity in the first direction are greater than or equal to 50 μm, and a height of a sound outlet hole corresponding to the third acoustic cavity in the first direction is greater than or equal to 100 um.

In some embodiments, the housing includes a front housing and a rear housing, at least two electrodes are disposed on the each fixing ring, and the at least two electrodes on the each fixing ring are respectively connected to the front housing or the rear housing through a corresponding conductive electrode.

In some embodiments, the at least some low-frequency bands include frequency bands that are less than 500 Hz.

In some embodiments, a sound generation unit of the plurality of sound generation units includes a flexible piezoelectric material, and a Young's modulus of the flexible piezoelectric material is in a range of 1.5 GPa-9 GPa.

In some embodiments, a sound generation unit of the plurality of sound generation units includes a first piezoelectric layer and a second piezoelectric layer arranged in the first direction, and a neutral layer of the sound generation unit is located between the first piezoelectric layer and the second piezoelectric layer.

In some embodiments, the sound generation unit further includes a first electrode layer, a second electrode layer, and a third electrode layer, and in the first direction, the first electrode layer, the first piezoelectric layer, the second electrode layer, the second piezoelectric layer, and the third electrode layer are arranged in sequence; and the first piezoelectric layer and the second piezoelectric layer are configured such that deformation directions of the first piezoelectric layer and the second piezoelectric layer are opposite to each other.

In some embodiments, a first driving voltage of the first piezoelectric layer is a difference between a first voltage of the first electrode layer and a second voltage of the second electrode layer, a second driving voltage of the second piezoelectric layer is a difference between the second voltage and a third voltage of the third electrode layer, and an absolute value of the first driving voltage and an absolute value of the second driving voltage are both not higher than 5 V.

In some embodiments, a sound generation unit of the plurality of sound generation units is disposed with one or more mass blocks.

In some embodiments, a sound generation unit of the plurality of sound generation units includes an electrode-covered region and a non-electrode-covered region.

In some embodiments, the non-electrode-covered region is located at a center of the sound generation unit, and a ratio of a first area of the electrode-covered region to an overhanging area of the sound generation unit is in a range of 0.28-0.84.

In some embodiments, the non-electrode-covered region is an annulus encircling a center of the sound generation unit, and a ratio of a second area of the non-electrode-covered region to an overhanging area of the sound generation unit is less than or equal to 0.27.

Embodiments of the present disclosure further provide an acoustic output device including: a low-frequency unit and a high-frequency unit, the low-frequency unit including a speaker of any one of claims 1-14. An intersection of frequency response curves of the low-frequency unit and the high-frequency unit is in a range of 300 Hz-1000 Hz.

In some embodiments, the high-frequency unit includes an air conduction speaker and/or a bone conduction speaker.

In some embodiments, the high-frequency unit operates at least in a frequency range whose lower boundary is the intersection.

In some embodiments, the acoustic output device has a height direction parallel to the first direction and a thickness direction perpendicular to the first direction. The low-frequency unit and the high-frequency unit are disposed along the height direction, and the low-frequency unit is disposed on a lower side of the high-frequency unit; or the low-frequency unit and the high-frequency unit are disposed along the thickness direction, and the high-frequency unit is disposed on a side of the acoustic output device close to a user.

In some embodiments, the high-frequency unit is acoustically coupled to a first sound outlet hole disposed on the acoustic output device, the low-frequency unit is acoustically coupled to a second sound outlet hole disposed on the acoustic output device, and the first sound outlet hole and the second sound outlet hole face the user. The first sound outlet hole and the second sound outlet hole are the same hole or different holes.

In some embodiments, the acoustic output device includes at least one of a rear hanging earphone, an earhook earphone, an in-ear earphone, and eyeglasses.

### BRIEF DESCRIPTION OF THE DRAWINGS

The present disclosure is further illustrated in terms of exemplary embodiments. These exemplary embodiments are described in detail with reference to the drawings. These embodiments are not limiting, and in these embodiments, the same numbering denotes the same structure, wherein:

FIG. 1A is a schematic diagram illustrating a structure of a speaker according to some embodiments of the present disclosure;

FIG. 1B is a schematic diagram illustrating a structure of a speaker according to some other embodiments of the present disclosure;

FIG. 1C is a schematic diagram illustrating a structure of a speaker according to some other embodiments of the present disclosure;

FIG. 2A is a diagram illustrating a structure of a speaker when a sound generation unit is not vibrating according to some embodiments of the present disclosure;

FIG. 2B is a diagram illustrating a structure of a speaker when the sound generation unit is vibrating according to some embodiments of the present disclosure;

FIG. 3A is a schematic diagram illustrating a structure of a fixing ring and electrodes according to some embodiments of the present disclosure;

FIG. 3B is a schematic diagram illustrating a cross-sectional view at A-A in FIG. 3A;

FIG. 4A is a schematic diagram illustrating a structure of a fixing ring and a sound generation unit according to some embodiments of the present disclosure;

FIG. 4B is a schematic diagram illustrating structures of a fixing ring, a sound generation unit, and a mass block according to some embodiments of the present disclosure;

FIG. 4C is a schematic diagram illustrating structures of a fixing ring, a sound generation unit, and a mass block according to some other embodiments of the present disclosure;

FIG. 4D is a schematic diagram illustrating a structure of a single-layer speaker according to some embodiments of the present disclosure;

FIG. 4E is a schematic diagram illustrating a structure of a single-layer speaker according to some other embodiments of the present disclosure;

FIG. 4F is a schematic diagram illustrating a structure of a single-layer speaker according to some embodiments of the present disclosure;

FIG. 5 is a schematic diagram illustrating a structure of a sound generation unit according to some embodiments of the present disclosure;

FIG. 6 is a schematic diagram illustrating a sound generation principle of a sound generation unit according to some embodiments of the present disclosure;

FIG. 7A is a schematic diagram illustrating an exemplary polarization and voltage scheme I according to some embodiments of the present disclosure;

FIG. 7B is a schematic diagram illustrating an exemplary polarization and voltage scheme II according to some embodiments of the present disclosure;

FIG. 7C is a schematic diagram illustrating an exemplary polarization and voltage scheme III according to some embodiments of the present disclosure;

FIG. 7D is a schematic diagram illustrating an exemplary polarization and voltage scheme IV according to some embodiments of the present disclosure;

FIG. 8A is a schematic diagram illustrating an exemplary a sound generation unit fully covered with electrodes according to some embodiments of the present disclosure;

FIG. 8B is a schematic diagram illustrating a deformation of a sound generation unit fully covered with electrodes according to some embodiments of the present disclosure;

FIG. 9A is a schematic diagram illustrating an exemplary sound generation unit partially covered with electrodes according to some embodiments of the present disclosure;

FIG. 9B is a schematic diagram illustrating a deformation of a sound generation unit partially covered with electrodes according to some embodiments of the present disclosure;

FIG. 10A is a graph illustrating frequency response curves corresponding to different α according to some embodiments of the present disclosure;

FIG. 10B is a local deformation cloud diagram of sound generation units corresponding to different α according to some embodiments of the present disclosure;

FIG. 11A is a schematic diagram illustrating an exemplary sound generation unit partially covered with dual-region electrodes according to some embodiments of the present disclosure;

FIG. 11B is a schematic diagram illustrating a deformation of a sound generation unit partially covered with dual-region electrodes according to some embodiments of the present disclosure;

FIG. 12 is a graph illustrating a frequency response curves corresponding to different β according to some embodiments of the present disclosure;

FIG. 13A is a schematic diagram illustrating a structure of a stacked (10-layer) speaker according to some embodiments of the present disclosure;

FIG. 13B is a graph illustrating frequency response curves of a stacked speaker and a single-layer speaker according to some embodiments of the present disclosure;

FIG. 14 is a schematic diagram illustrating an exemplary acoustic output device according to some embodiments of the present disclosure;

FIG. 15A is a schematic diagram I illustrating an exemplary acoustic output device according to some other embodiments of the present disclosure;

FIG. 15B is a schematic diagram II illustrating an exemplary acoustic output device according to some embodiments of the present disclosure;

FIG. 16 is a schematic diagram illustrating an exemplary acoustic output device according to some other embodiments of the present disclosure;

FIG. 17 is a graph illustrating frequency response curves of an acoustic output device according to some embodiments of the present disclosure.

### DESCRIPTION OF REFERENCE SIGNS

100—speaker, 110—sound generation unit, 1101—first sound generation unit, 1102—second sound generation unit, 1103—third sound generation unit, 1104—fourth sound generation unit, 110n—nth sound generation unit, 111—piezoelectric layer, 1111—first piezoelectric layer, 1112—second piezoelectric layer, 112—neutral layer, 113—electrode layer, 1131—first electrode layer, 1132—second electrode layer, 1133—third electrode layer, 120—housing, 120—front housing, 1202—rear housing, 121—sound outlet hole (including 1211, 1212, 1212—1, 1212—2, 1213—1 . . . 121i . . . 121 (n+1)), 122—acoustic cavity, 1221—first acoustic cavity, 1222—second acoustic cavity, 1223—third acoustic cavity, 123—fixing ring, 1231—first fixing ring, 1232—second fixing ring, 130—mass block, 140—dust/damping mesh, 1401—front cavity dust/damping mesh, 1402—rear cavity dust/damping mesh, 200—acoustic output device, 201—first sound outlet hole, 202—second sound outlet hole, and 203—third sound outlet hole.

### DETAILED DESCRIPTION

To more clearly illustrate the technical solutions of the embodiments of the present disclosure, the accompanying drawings required to be used in the description of the embodiments are briefly described below. Obviously, the accompanying drawings in the following description are only some examples or embodiments of the present disclosure, and it is possible for those skilled in the art to apply the present disclosure to other similar scenarios in accordance with these drawings without creative labor. Unless obviously obtained from the context or the context illustrates otherwise, the same numeral in the drawings refers to the same structure or operation.

It should be understood that the terms “system”, “device,” “unit,” and/or “module” as used herein as used as a way to distinguish between different components, elements, parts, sections or assemblies at different levels. However, the words may be replaced by other expressions if other words accomplish the same purpose.

As shown in the present disclosure and in the claims, unless the context clearly suggests an exception, the words “a,” “one,” “anm” and/or “the” do not refer specifically to the singular but may also include the plural. In general, the terms “including” and “comprising” only suggest the inclusion of explicitly identified operations and elements that do not constitute an exclusive list, and the method or apparatus may also include other operations or elements.

Flowcharts are used in the present disclosure to illustrate operations performed by a system in accordance with embodiments of the present disclosure. It should be appreciated that the preceding or following operations are not necessarily performed in an exact sequence. Instead, operations may be processed in reverse order or simultaneously. Also, it is possible to add other operations to these processes or remove an operation or operations from these processes.

Current consumer electronics, including open binaural earphones, audio glasses, true wireless stereo (TWS) earphones, etc., progressively increase requirements for an output sound pressure level in the low-frequency band. If the existing air conduction electromagnetic speakers need to output a sufficient output sound pressure level at the low frequency, a large motion stroke and a large thickness size are required, which poses a greater challenge to a product size. Whereas the piezoelectric speaker is thinner, and some embodiments of the present disclosure provide a speaker that employs a plurality of piezoelectric sound generation units to be stacked and superimposed to form a stacked speaker. A count of the sound generation units (i.e., a layer count) in the stacked speaker may be set in accordance with actual product sizes at different positions and required sound pressure level output effects in different use scenarios, so that a greater low-frequency output is obtained with a smaller size of the speaker.

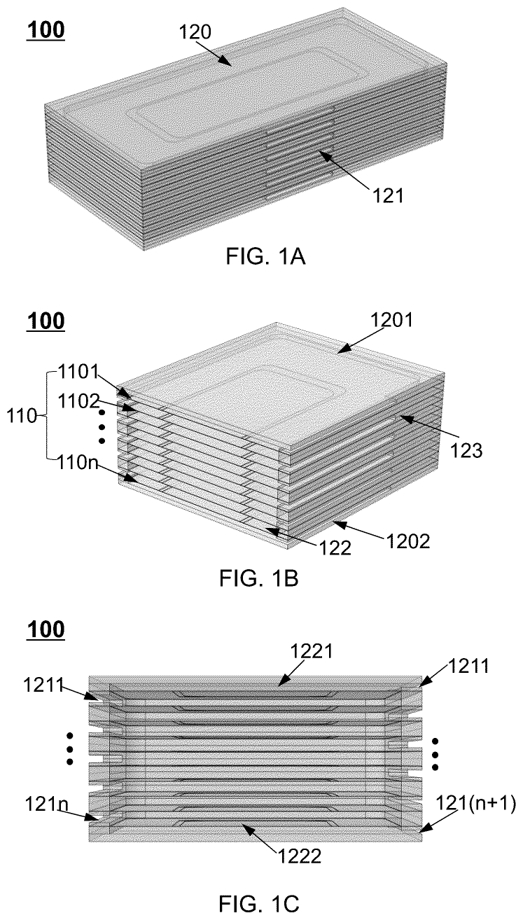

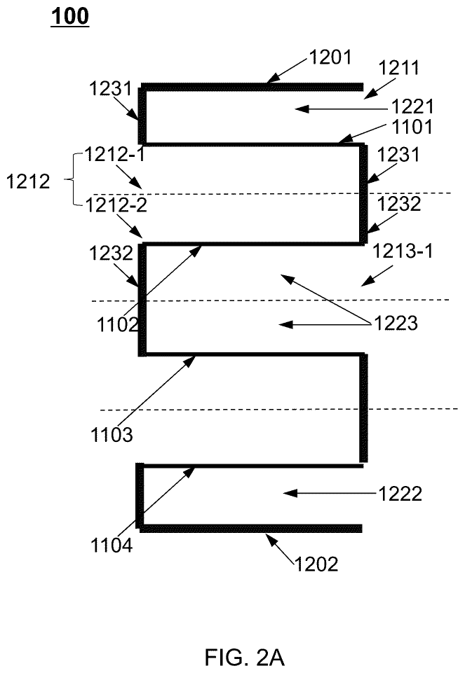

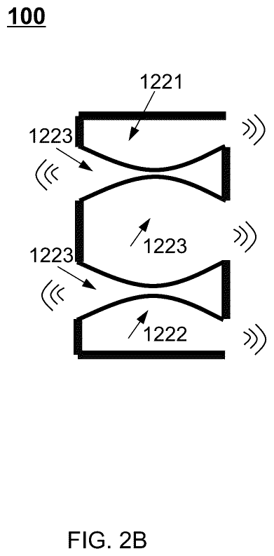

FIG. 1A is a schematic diagram illustrating a structure of a speaker according to some embodiments of the present disclosure; FIG. 1B is a schematic diagram illustrating a structure of a speaker according to some other embodiments of the present disclosure; FIG. 1C is a schematic diagram illustrating a structure of a speaker according to some other embodiments of the present disclosure; FIG. 2A is a diagram illustrating a structure of a speaker when a sound generation unit is not vibrating according to some embodiments of the present disclosure; FIG. 2B is a diagram illustrating a structure of a speaker when the sound generation unit is vibrating according to some embodiments of the present disclosure.

As shown in FIGS. 1A-1C, some embodiments of the present disclosure provide a speaker 100 including a plurality of sound generation units 110 spaced apart along a first direction, and a housing 120.

The first direction refers to a direction in which the plurality of sound generation units 110 of the speaker 100 are stacked. For example, the first direction is a vertical upward direction or a vertical downward direction. In some embodiments, the first direction is the thickness direction of the sound generation unit 110.

In some embodiments, the housing 120 is used to accommodate and support a plurality of sound generation units 110. In some embodiments, the housing 120 is a one-piece molding structure or a split structure. For example, the housing 120 is formed by combining a plurality of structural members using bonding, snap connections, etc.

In some embodiments, a plurality of sound outlet holes 121 are disposed on the housing 120, the housing 120 and the plurality of sound generation units 110 enclose a plurality of acoustic cavities 122, and each of the acoustic cavities 122 is acoustically coupled to at least one sound outlet hole 121 on the housing 120.

The acoustic cavity 122 refers to a cavity structure in the speaker 100. In some embodiments, an acoustic cavity 122 is enclosed between the housing 120 and the sound generation unit 110 and/or between two adjacent sound generation units 110. As shown in FIG. 1C, when there are n sound generation units 110, there are n+1 acoustic cavities 122. More content about the acoustic cavity may be found in FIGS. 2A-2B and the related descriptions.

The sound outlet hole 121 refers to a structure in the speaker 100 that is used to radiate sound to the outside. In some embodiments, the sound outlet holes 121 are disposed in correspondence with the acoustic cavities 122, i.e., one acoustic cavity 122 corresponds to at least one sound outlet hole 121. In some embodiments, a count of the sound outlet holes 121 is the same as the count of acoustic cavities 122. As shown in FIG. 1C, when there are n sound generation units 110, there are n+1 acoustic cavities 122, and there are n+1 sound outlet holes 121. More content about the sound outlet holes may be found in FIGS. 2A-2B and the related descriptions.

The sound generation unit 110 is an element in the speaker 100 that is used to vibrate to generate sound. In some embodiments, a specific count of the sound generation units 110 is not limited, and it may be set based on actual needs. For example, the count is determined based on a requirement for a sound pressure level of the speaker 100; as another example, the count is determined based on a thickness of the speaker 100, etc. As shown in FIG. 1B, the sound generation unit 110 may include a first sound generation unit 1101, a second sound generation unit 1102, . . . , and a nth sound producing unit 110n.

In some embodiments, the plurality of sound generation units 110 are spaced apart in the housing 120 along the first direction, and the plurality of sound generation units 110 all vibrate along the first direction. In some embodiments, as shown in FIG. 2B, under an excitation signal, two adjacent sound generation units, which are among the plurality of sound generation units 110 and share at least one of the plurality of acoustic cavities 122, vibrate in opposing directions. It is noted that, under the excitation signal, the two sound generation units 110 adjacent to each other and share at least one of the plurality of acoustic cavities 122 may vibrate in opposite directions in a full frequency band to enhance an output sound pressure level of the speaker 100 in the full frequency band. In some embodiments, under the excitation signal, two adjacent sound generation units, which are among the plurality of sound generation units 110 and share at least one of the plurality of acoustic cavities 122, vibrate in opposite directions in at least some low-frequency bands to enhance the output sound pressure level of the acoustic output device (e.g., an acoustic output device 200) including the speaker 100 in the at least some low-frequency bands to satisfy a gradually increasing requirement of the acoustic output device for the output sound pressure level in the low-frequency bands.

In some embodiments, at least some low-frequency bands include frequency bands less than 500 Hz. In some embodiments, at least some low-frequency bands include frequency bands less than 300 Hz. For example, the frequency band is in a range of 50 Hz-100 Hz; as another example, the frequency band is in a range of 100 Hz-150 Hz; as a further example, the frequency band is in a range of 150 Hz-280 Hz, etc.

In some embodiments, the plurality of sound generation units 110 all vibrating in the first direction includes that at least one sound generation unit 110 vibrates in the vertically upward direction and/or at least one sound generation unit 110 vibrates in the vertically downward direction. Further, the plurality of sound generation units 110 all vibrating in the first direction may include that two sound generation units 110 that are adjacent to each other and share at least one acoustic cavity 122 vibrate in opposite directions in at least some low-frequency bands. As shown in FIGS. 2A-2B, the first sound generation unit 1101 vibrates in the vertically downward direction, the second sound generation unit 1102 vibrates in the vertically upward direction; a third sound generation unit 1103 vibrates in the vertically downward direction, and a fourth sound generation unit 1103 vibrates in the vertically upward direction.

In some embodiments, by controlling excitation voltages of the plurality of sound generation units 110 such that a phase difference between the excitation voltages of the two sound generation units 110 of the at least one acoustic cavity 122 is 180°, the two sound generation units 110 that are adjacent to each other and share the at least one acoustic cavity 122 may vibrate in opposite directions in at least some low-frequency bands. Based on a fact that the two sound generation units 110 that are adjacent to each other and share the at least one acoustic cavity 122 vibrate in opposite directions in at least some low-frequency bands, in conjunction with the design of the sound outlet holes 121 as shown in some embodiments of the present disclosure, the sound pressure level of the output of the speaker 100 (a stacked speaker) with n sound generation units 110 is increased by 20×log₁₀(n) compared to the output of the speaker 100 (a single-layer speaker) with only one sound generation unit 110.

More content about the sound generation unit may be found in FIGS. 2A-2B, FIGS. 4A-13B, and the related descriptions.

In some embodiments of the present disclosure, as the thickness of the piezoelectric speaker is thin, a greater low-frequency output can be obtained while satisfying a small design size of the speaker by arranging a plurality of piezoelectric sound generation units spaced apart in the first direction (the thickness direction). Based on actual demand and by flexibly adjusting the count of the sound generation units in the first direction, the speakers can be applied to more use scenarios, so that the speaker has a wide range of applicability and practicality.

The housing 120 may include a plurality of fixing rings 123, as shown in FIG. 1B, and FIGS. 2A-2B.

The fixing ring 123 refers to a structure for fixing the sound generation unit 110. In some embodiments, in the first direction, the sound generation unit 110 is disposed within the fixing ring 123. In some embodiments, in the first direction, the sound generation unit 110 is disposed in a middle position of the fixing ring 123, i.e., the fixing ring 123 is evenly distributed on both sides of the sound generation unit 110.

In some embodiments, each fixing ring 123 fixes one sound generation unit 110, each fixing ring 123 is disposed with two sound outlet holes 121 at a peripheral side of the fixing ring 123, and the two sound outlet holes 121 are respectively coupled with the acoustic cavities 122 on opposite sides of the sound generation unit 110.

The peripheral side of the fixing ring 123 may be understood as a surrounding of the fixing ring 123. For example, when the speaker 100 is designed as a rectangular structure, the peripheral side of the fixing ring 123 includes a pair of long sides and a pair of short sides. In some embodiments, the sound outlet holes 121 are disposed on opposite sides (e.g., opposite long sides or opposite short sides) of the fixing ring 123 or disposed adjacently (e.g., adjacent long sides or short sides) on adjacent sides of the fixing ring 123 to couple with two different acoustic cavities 122, respectively.

As shown in FIG. 2A, a dotted line indicates a connecting surface of the two adjacent fixing rings 123, a peripheral side of a first fixing ring 1231 is disposed with two sound outlet holes, namely, a sound outlet hole 1211 and a sound outlet hole 1212-1. A peripheral side of a second fixing ring 1232 of the first fixing ring 1231 is disposed with two sound outlet holes, namely, a sound outlet hole 1212-2 and a sound outlet hole 1213-1. The sound outlet hole 1212-1 is in flow communication with the sound outlet hole 1212-2 to form a whole sound outlet hole 1212 that is coupled with the acoustic cavity 122. In some embodiments, the plurality of fixing rings 123 are integrally molded, at which point, the housing 120 is considered to include only one fixing ring 123, and the plurality of sound generation units 110 are all disposed within one fixing ring 123.

In some embodiments, the housing 120 includes a front housing 1201 and a rear housing 1202. A first acoustic cavity 1221 is formed between the front housing 1201 and its adjacent sound generation unit 110, a second acoustic cavity 1222 is formed between the rear housing 120 and another adjacent sound generation unit 110, and a third acoustic cavity 1223 is formed between the two adjacent sound generation units 110.

As shown in FIGS. 2A-2B, a first acoustic cavity 1221 may be formed between the front housing 1201 and the first sound generation unit 1101, a second acoustic cavity 1222 may be formed between the rear housing 1202 and the fourth sound generation unit 1104, and third acoustic cavities 1223 are formed between the first sound generation unit 1101 and the second sound generation unit 1102, and between the second sound generation unit 1102 and the third sound generation unit 1103, respectively.

In some embodiments, the thickness of the first acoustic cavity 1221 and/or the second acoustic cavity 1222 in the first direction is less than the thickness of the third acoustic cavity 1223 in the first direction. It is appreciated that, as shown in FIGS. 2A-2B, as the first acoustic cavity 1221 and the second acoustic cavity 1222 are respectively formed by the sound generation unit 110 with the front housing 1201 and the rear housing 1202, the third acoustic cavity 1223 is formed based on two adjacent sound generation units 110, and as each of the sound generation units 110 has fixing rings 123 uniformly distributed on both sides of the sound generation unit 110, the thickness of the third acoustic cavity 1223 in the first direction is greater than the thickness of the first acoustic cavity 1221 and/or the second acoustic cavity 1222 in the first direction.

Further, in some embodiments, in the first direction, the sizes of the sound outlet holes 121 corresponding to the first acoustic cavity 1221 and/or the second acoustic cavity 1222 are smaller than the size of the sound outlet hole 121 corresponding to the third acoustic cavity 1223. The size of the acoustic outlet hole 121 includes, but is not limited to, a height of the acoustic outlet hole 121 in the first direction, etc.

In some embodiments of the present disclosure, based on the fact that two sound generation units that are adjacent to each other and share at least one acoustic cavity vibrate in opposite directions in at least some low-frequency bands, and combining the design of the sound outlet holes as shown in some embodiments of the present disclosure, the sound pressure level output by the speaker with n sound generation units (the stacked speaker) is increased compared to the output of the speaker with only one sound generation unit (the single-layer speaker). Then, by taking advantage of the small thickness of the single-layer sound generation unit, the speaker with a smaller thickness and a greater low-frequency output sound pressure level may be realized.

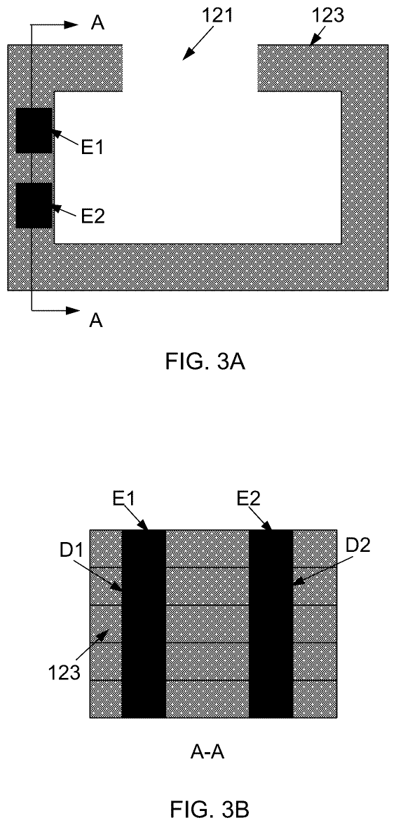

FIG. 3A is a schematic diagram illustrating a structure of a fixing ring and electrodes according to some embodiments of the present disclosure; and FIG. 3B is a schematic diagram illustrating a cross-sectional view at A-A in FIG. 3A.

In some embodiments, the housing 120 includes the front housing 1201 and the rear housing 1202, with at least two electrodes disposed on each of the fixing rings 123, and the at least two electrodes on the each fixing ring 123 are respectively connected to the front housing 1201 or the rear housing 1202 through a corresponding conductive electrode.

In some embodiments, the count of electrodes on each fixing ring 123 includes, but is not limited to, two. For example, based on actual needs, the count of electrodes on each fixing ring is three. As shown in FIGS. 3A-3B, the fixing ring 123 includes two electrodes, i.e., electrode E1 and electrode E2.

In some embodiments, based on at least two electrodes (e.g., the electrode E1, and the electrode E2) on each fixing ring 123, an excitation signal (e.g., an excitation voltage) is provided for the sound generation unit 110 fixed to the fixing ring 123.

The conductive electrode is an electrode structure that connects the corresponding electrodes on each of the fixed rings 123. As shown in FIG. 3B, a first conductive electrode D1 may connect the electrode E1 on each of the fixing rings 123 to the front housing 1201 or the rear housing 1202, and a second conductive electrode D2 may connect the electrode E2 on each of the fixing rings 123 to the front housing 1201 or the rear housing 1202.

In some embodiments, the fixing ring 123 includes one or more of an FR4, a flexible printed circuit (FPC), and plastic, and the fixing ring 123 is disposed with at least two conductive holes extending in the first direction. The at least two electrodes are disposed in the corresponding conductive holes. The electrodes corresponding to any two adjacent fixing rings 123 may be conducted to each other to form the conductive electrode. The conduction refers to that the electrodes are electrically connected to other.

For example, when the fixing ring 123 adopts the FR4 and the FPC, a conduction between two end surfaces of the fixing rings 123 is realized directly through the conductive holes, and then by coating a conductive silver paste, a conductive glue, a patch, etc., the at least two electrodes on each fixing ring 123 are connected to each other to form the corresponding conductive electrode. As another example, when the fixing ring 123 is made of a resin polymer material such as plastic, metal electrodes are disposed in the conductive holes to achieve conduction between the electrodes corresponding to any two connected fixing rings 123 to form the conductive electrode.

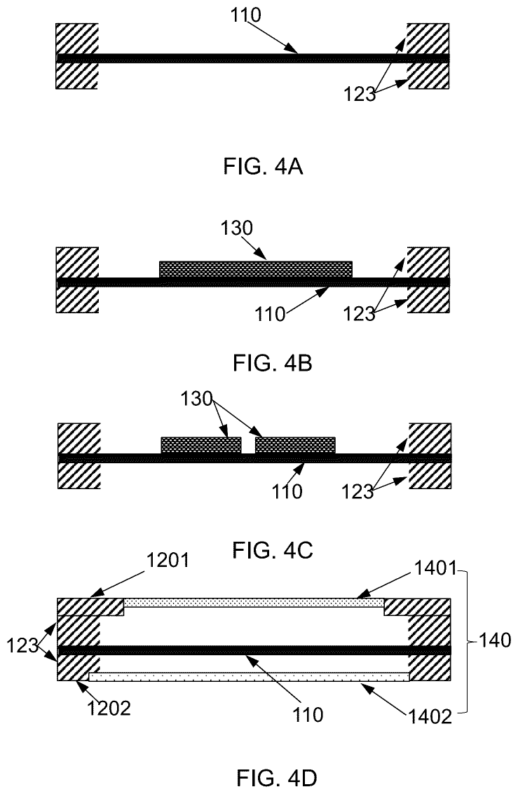

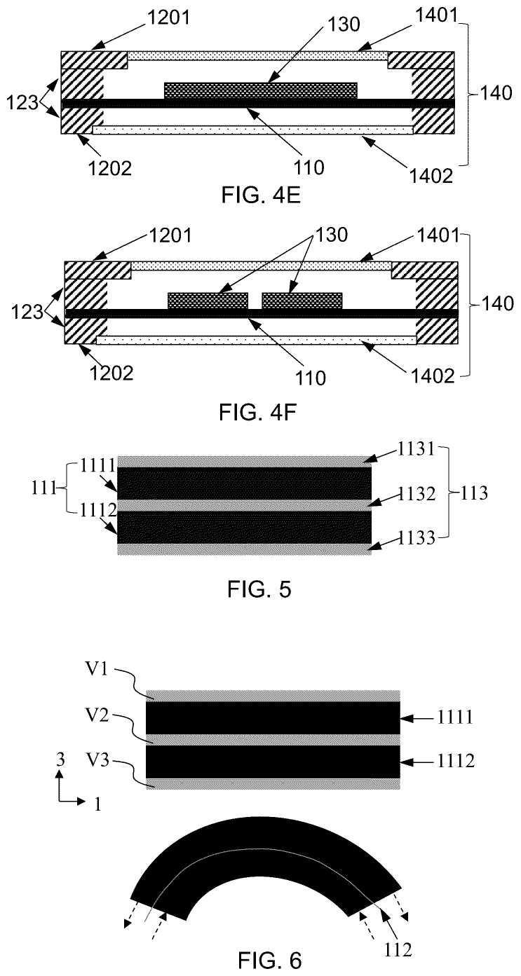

FIG. 4A is a schematic diagram illustrating a structure of a fixing ring and a sound generation unit according to some embodiments of the present disclosure; FIG. 4B is a schematic diagram illustrating structures of a fixing ring, a sound generation unit, and a mass block according to some embodiments of the present disclosure; and FIG. 4C is a schematic diagram illustrating structures of a fixing ring, a sound generation unit, and a mass block according to some other embodiments of the present disclosure.

As shown in FIG. 4A, in the speaker 100 (a stacked speaker) with a plurality (e.g., n) of sound generation units 110, a single sound generation unit 110 is disposed at a middle position of the fixing ring 123, i.e., the fixing ring 123 is uniformly disposed on both sides of the sound generation unit 110.

In some embodiments, one or more mass blocks 130 are disposed on the sound generation unit 110. For example, a count of the mass blocks 130 is 1, 2, 3, etc.

As shown in FIG. 4, the mass block 130 may be disposed on the sound generation unit 110 fixed within the fixing ring 123. In some embodiments, a structure and a size of the mass block 130 are not limited, and are disposed based on actual needs.

In some embodiments of the present disclosure, a resonant frequency F0 of the speaker is regulated by disposing the mass block on the sound generation unit.

As shown in FIG. 4C, two mass blocks 130 may be disposed on the sound generation unit 110 fixed within the fixing ring 123. The structures and the sizes of the two mass blocks 130 are not limited, which are the same or different, and are set based on actual needs.

In some embodiments of the present disclosure, by increasing the count of the mass blocks 130 on the sound generation unit 110, the resonance frequency F0 of the speaker is further adjusted, so as to enable the speaker to better satisfy the requirements of different users and different usage scenarios.

FIG. 4D is a schematic diagram illustrating a structure of a single-layer speaker according to some embodiments of the present disclosure; FIG. 4E is a schematic diagram illustrating a structure of a single-layer speaker according to some other embodiments of the present disclosure; and FIG. 4F is a schematic diagram illustrating a structure of a single-layer speaker according to some embodiments of the present disclosure.

In some embodiments, the speaker 100 (a single-layer speaker) with only one sound generation unit 110 may include not only the sound generation unit 110 and the fixing ring 123, wherein the sound generation unit 110 is disposed at a middle position of the fixing ring 123, a but also the front housing 1201, the rear housing 1202, and a dustproof/damping mesh 140 connected to the front housing 1201 and the rear housing 1202.

As shown in FIGS. 4D-4F, the front housing 1201 and the rear housing 1202 are connected to two end surfaces of the fixing ring 123 in a first direction, respectively. In a direction perpendicular to the first direction, the front housing 1201 and the rear 1202 are respectively disposed with a front cavity dustproof/damping mesh 1401 and a rear cavity dustproof/damping mesh 1402. The front housing 1201, the front cavity dustproof/damping mesh 1401, an upper portion of the fixing ring 123, and an upper side of the sound generation unit 110 together enclose the front cavity of the speaker 100; and the rear cavity 1202, the dustproof/damping mesh 1402, a lower portion of the fixing ring 123, and a lower side of the sound generation unit 110 together enclose the rear cavity of the speaker 100. In some embodiments, as shown in FIG. 1A, in the speaker 100 including a plurality of sound generation units 110 spaced apart in the first direction, the sound outlet hole 121 corresponding to each of the plurality of acoustic cavities 122 is disposed with the dustproof/damping mesh 140 to realize a dustproof encapsulation. In some embodiments, for the speaker 100 shown in FIG. 1A, the dustproof encapsulation is not performed between two adjacent sound generation units 110, such that the front cavity and the rear cavity disposed between the two adjacent sound generation units 110 are not separated, and the acoustic cavity 122 is formed. In some embodiments, for the speaker 100 as shown in FIG. 1A, the dustproof encapsulation (e.g., the dustproof/damping mesh 140 disposed between two adjacent sound generation units 110, which is not shown in the figure) is performed between two adjacent sound generation units 110, so as to regulate an output sound pressure level as well as a Q value of an output frequency response of the speaker 100.

In some embodiments, within the front cavity of the speaker 100, the sound generation unit 110 is disposed with the mass block 130 or is not disposed with the mass block 130, which is determined based on the actual requirements.

FIG. 5 is a schematic diagram illustrating a structure of a sound generation unit according to some embodiments of the present disclosure; and FIG. 6 is a schematic diagram illustrating a sound generation principle of a sound generation unit according to some embodiments of the present disclosure.

In some embodiments, the sound generation unit 110 includes a flexible piezoelectric material. For example, the sound generation unit 110 includes, but is not limited to, polyvinylidene fluoride (PVDF), copolymers of polyvinylidene fluoride (e.g., vinylidene fluoride-trifluoro ethylene copolymer), etc.

In some embodiments, a Young's modulus of the flexible piezoelectric material is in a range of 1.5 GPa-9 GPa. For example, the Young's modulus of the flexible piezoelectric material is in a range of 1.5 GPa-5 GPa, 3 GPa-7 GPa, 5 GPa-9 GPa, or other interval ranges.

In some embodiments of the present disclosure, the flexible piezoelectric material is used in the sound generation unit such that the sound generation unit has a vibration function and a driving function at the same time.

As shown in FIGS. 5-6, the sound generation unit 110 includes a first piezoelectric layer 1111 and a second piezoelectric layer 1112 arranged in a first direction, and a neutral layer 112 of the sound generation unit 110 is disposed between the first piezoelectric layer 1111 and the second piezoelectric layer 1112.

In some embodiments, the sound generation unit 110 further includes a first electrode layer 1131, a second electrode layer 1132, and a third electrode layer 1133. In a first direction, the first electrode layer 1131, the first piezoelectric layer 1111, the second electrode layer 1132, the second piezoelectric layer 1112, and the third electrode layer 1133 are sequentially arranged. The first piezoelectric layer 1111 and the second piezoelectric layer 1112 are configured to have opposite deformations. That is, when the first piezoelectric layer 1111 is stretched, the second piezoelectric layer 1112 is shortened; or, when the first piezoelectric layer 1111 is shortened, the second piezoelectric layer 1112 is stretched. Combined with the setting of the neutral layer 112 of the sound generation unit 110 between the first piezoelectric layer 1111 and the second piezoelectric layer 1112, the deformation amount of the sound generation unit 110 may be increased.

In some embodiments, the first piezoelectric layer 1111 and the second piezoelectric layer 1112 are collectively referred to as a piezoelectric layer 111; and the first electrode layer 1131, the second electrode layer 1132, and the third electrode layer 1133 are collectively referred to as an electrode layer 113. The piezoelectric layer 111 refers to a layered structure capable of realizing an inverse piezoelectric effect, and the electrode layer 113 refers to a layered structure capable of realizing a current conduction.

In some embodiments, when the speaker 100 generates sound, the sound generation unit 110 needs to deform in the first direction and further displace in the first direction to push air in the acoustic cavities 122 on the upper and lower sides of the sound generation unit 110 to radiate a sound pressure, thereby generating sound.

In some embodiments, when the sound generation unit 110 is the flexible piezoelectric material (e.g., the PVDF), the sound generation unit 110 has a d33 mode and a d31 mode. Further, when voltages V1, V2, and V3 are applied to the first electrode layer 1131, the second electrode layer 1132, and the third electrode layer 1133, respectively, in both the first direction (the 3 direction shown in FIG. 6) and the direction perpendicular to the first direction (the 1 direction shown in FIG. 6), the sound generation unit 110 generates a telescopic deformation. If only the d33 mode in the first direction is used, the deformation amount of the sound generation unit 110 is extremely small, and the sound pressure level output by the sound generation unit 110 may not satisfy the actual requirements, thus it is necessary to use the d31 mode in the direction perpendicular to the first direction.

In some embodiments, to convert the expansion and contraction deformation in the direction perpendicular to the first direction into a forward and backward displacement of the sound generation unit 110 in the first direction, deformation directions of the first piezoelectric layer 1111 and the second piezoelectric layer 1112 should be opposite. For example, the first piezoelectric layer 1111 produces a tensile deformation in the first direction, and the second piezoelectric layer 1112 produces a shortening deformation in the first direction; or the first piezoelectric layer 1111 produces a shortening deformation in the first direction, and the second piezoelectric layer 1112 produces a tensile deformation in the first direction. At this time, as shown in FIG. 6, the neutral layer 113 is disposed between the first piezoelectric layer 1111 and the second piezoelectric layer 1112. The length of the neutral layer 113 remains unchanged during the deformation of the sound generation unit 110, and the piezoelectric layers 111 on the upper and lower sides of the neutral layer 113 deform in opposite directions, so that the tensile and shortening deformation in the direction perpendicular to the first direction is converted into a large forward and backward displacement of the sound generation unit 110 in the first direction, and the sound pressure level radiated by the sound generation unit 110 is enhanced.

In some embodiments, as the sound generation unit 110 is the flexible piezoelectric material, the sound generation unit 110 has a polarization direction, and applying a voltage at different positions along a polarization direction generates different deformation effects. For example, the piezoelectric layer 111 produces a tensile deformation when an electric potential direction is the same as the polarization direction, and the piezoelectric layer 111 produces a shortening deformation when the electric potential direction is opposite to the polarization direction. Based on this, the deformation directions of the first piezoelectric layer 1111 and the second piezoelectric layer 1112 may be made opposite to each other in different manners.

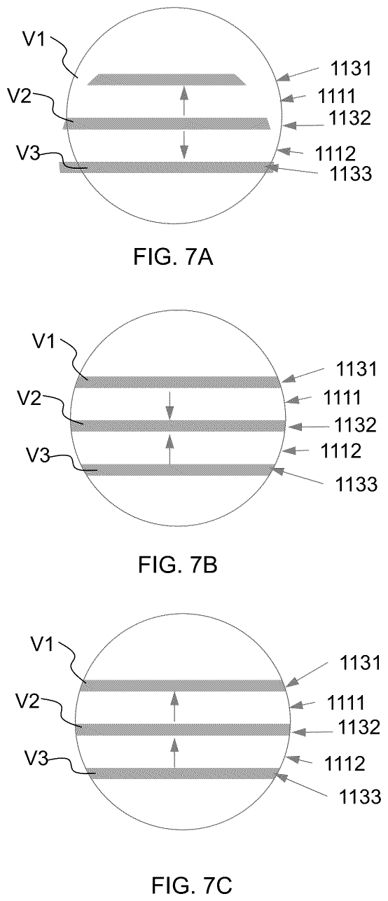

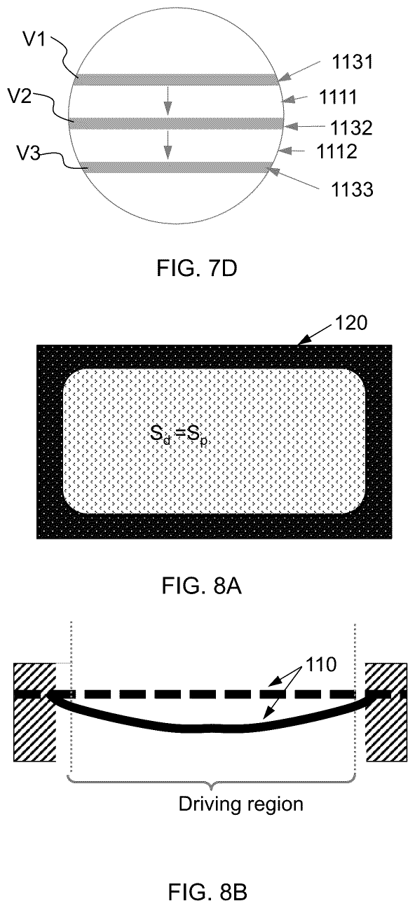

FIG. 7A is a schematic diagram illustrating an exemplary polarization and voltage scheme I according to some embodiments of the present disclosure; FIG. 7 B is a schematic diagram illustrating an exemplary polarization and voltage scheme II according to some embodiments of the present disclosure; FIG. 7C is a schematic diagram illustrating an exemplary polarization and voltage scheme III according to some embodiments of the present disclosure; FIG. 7D is a schematic diagram illustrating an exemplary polarization and voltage scheme IV according to some embodiments of the present disclosure.

As shown in FIGS. 7A-7D, arrows inside the first piezoelectric layer 1111 and the second piezoelectric layer 1112 indicate a polarization direction of the corresponding piezoelectric layer 111, and the corresponding V1, V2, and V3 indicate externally applied excitation voltages when the speaker 100 operates.

In some embodiments, the first piezoelectric layer 1111 is polarized in an opposite direction to the second piezoelectric layer 1112 as shown in FIG. 7A and FIG. 7B. The first voltage V1 of the first electrode layer 1131, the second voltage V2 of the second electrode layer 1132, and the third voltage V3 of the third electrode layer 1133 are sequentially reduced or sequentially increased, i.e., V1>V2>V3 or V1<V2<V3.

As shown in FIG. 7A, the first piezoelectric layer 1111 and the second piezoelectric layer 1112 are polarized in opposite directions, with the first piezoelectric layer 1111 polarized in an upward direction and the second piezoelectric layer 1112 polarized in a downward direction. When the first voltage V1 of the first electrode layer 1131, the second voltage V2 of the second electrode layer 1132, and the third voltage V3 of the third electrode layer 1133 decrease in sequence (i.e., V1>V2>V3), a potential direction of the first piezoelectric layer 1111 is downward and opposite to the polarization direction of the first piezoelectric layer 1111, and the first piezoelectric layer 1111 produces a shortening deformation. A potential direction of the second piezoelectric layer 1112 is downward and is the same as the polarization direction of the second piezoelectric layer 1112, and the second piezoelectric layer 1112 produces a tensile deformation, and the sound generation unit 110 as a whole displaces downward in the first direction. When the first voltage V1 of the first electrode layer 1131, the second voltage V2 of the second electrode layer 1132, and the third voltage V3 of the third electrode layer 1133 increase in sequence (i.e., V1<V2<V3), the potential direction of the first piezoelectric layer 1111 is upward, which is the same as the polarization direction of the first piezoelectric layer 1111, and the first piezoelectric layer 1111 produces a tensile deformation. The potential direction of the second piezoelectric layer 1112 is upward, which is opposite to the polarization direction of the second piezoelectric layer 1112, the second piezoelectric layer 1112 produces a shortening deformation, and the sound generation unit 110 as a whole displaces upward in the first direction.

As shown in FIG. 7B, the first piezoelectric layer 1111 and the second piezoelectric layer 1112 are polarized in opposite directions, with the polarization direction of the first piezoelectric layer 1111 being downward and the polarization direction of the second piezoelectric layer 1112 being upward. When the first voltage V1 of the first electrode layer 1131, the second voltage V2 of the second electrode layer 1132, and the third voltage V3 of the third electrode layer 1133 decrease in sequence (i.e., V1>V2>V3), the potential direction of the first piezoelectric layer 1111 is downward, which is in the same direction as the polarization direction of the first piezoelectric layer 1111, the first piezoelectric layer 1111 produces a tensile deformation. The potential direction of the second piezoelectric layer 1112 is downward, which is opposite to the polarization direction of the second piezoelectric layer 1112, the second piezoelectric layer 1112 produces a shortening deformation, and the sound generation unit 110 as a whole displaces upward in the first direction. When the first voltage V1 of the first electrode layer 1131, the second voltage V2 of the second electrode layer 1132, and the third voltage V3 of the third electrode layer 1133 increase in sequence (i.e., V1<V2<V3), the potential direction of the first piezoelectric layer 1111 is upward, which is opposite to the polarization direction of the first piezoelectric layer 1111, the first piezoelectric layer 1111 produces a shortening deformation. The potential direction of the second piezoelectric layer 1112 is upward, which is opposite to the polarization direction of the second piezoelectric layer 1112, the second piezoelectric layer 1112 produces a tensile deformation, and the sound generation unit 110 as a whole displaces downward in the first direction.

In some embodiments, the first piezoelectric layer 1111 and the second piezoelectric layer 1112 have the same polarization direction, and the first voltage V1 of the first electrode layer 1131 and the third voltage V3 of the third electrode layer 1133 are both greater than or less than the second voltage V2 of the electrode layer 1132, i.e., V1>V2, V3>V2, or V1<V2, V3<V2. Furthermore, V1 may be equal to V3, and V2 may be 0 V.

As shown in FIG. 7C, the first piezoelectric layer 1111 and the second piezoelectric layer 1112 have the same polarization direction, and the polarization direction of the first piezoelectric layer 1111 and the second piezoelectric layer 1112 are both upward. When the first voltage V1 of the first electrode layer 1131 and the third voltage V3 of the third electrode layer 1133 are both greater than the second voltage V2 of the second electrode layer 1132 (i.e., V1>V2, and V3>V2), the potential direction of the first piezoelectric layer 1111 is downward, which is opposite to the polarization direction of the first piezoelectric layer 1111, and the first piezoelectric layer 1111 produces a shortening deformation. The potential direction of the first piezoelectric layer 1111 is upward, which is in the same direction as the polarization direction of the second piezoelectric layer 1112, the second piezoelectric layer 1112 produces a tensile deformation, and the sound generation unit 110 as a whole displaces downward in the first direction. When the first voltage V1 of the first electrode layer 1131 and the third voltage V3 of the third electrode layer 1133 are both smaller than the second voltage V2 of the second electrode layer 1132 (i.e., V1<V2, and V3<V2), the potential direction of the first piezoelectric layer 1111 is upward, which is in the same direction as the polarization direction of the first piezoelectric layer 1111, and the first piezoelectric layer 1111 produces a tensile deformation. The potential direction of the second piezoelectric layer 1112 is downward, which is opposite to the polarization direction of the second piezoelectric layer 1112, and the second piezoelectric layer 1112 produces a shortening deformation, and the sound generation unit 110 as a whole displaces upward in the first direction.

As shown in FIG. 7D, the first piezoelectric layer 1111 and the second piezoelectric layer 1112 have the same polarization direction, and the polarization direction of the first piezoelectric layer 1111 and the polarization direction of the second piezoelectric layer 1112 are both downward. When the first voltage V1 of the first electrode layer 1131 and the third voltage V3 of the third electrode layer 1133 are both greater than the second voltage V2 of the second electrode layer 1132 (i.e., V1>V2, and V3>V2), the potential direction of the first piezoelectric layer 1111 is downward, which is in the same direction as the polarization direction of the first piezoelectric layer 1111, the first piezoelectric layer 1111 produces a tensile deformation. The potential direction of the second piezoelectric layer 1112 is upward, which is opposite to the polarization direction of the second piezoelectric layer 1112, the second piezoelectric layer 1112 produces a shortening deformation, and the sound generation unit 110 as a whole displaces upward in the first direction. When the first voltage V1 of the first electrode layer 1131 and the third voltage V3 of the third electrode layer 1133 are both smaller than the second voltage V2 of the second electrode layer 1132 (i.e., V1<V2, and V3<V2), the potential direction of the first piezoelectric layer 1111 is upward, which is opposite to the polarization direction of the first piezoelectric layer 1111, and the first piezoelectric layer 1111 produces a shortening deformation. The potential direction of the second piezoelectric layer 1112 is downward, which is the same as the polarization direction of the second piezoelectric layer 1112, the second piezoelectric layer 1112 produces a tensile deformation, and the sound generation unit 110 as a whole is displaced downward in the first direction.

In some embodiments, a first driving voltage ΔV1 of the first piezoelectric layer 1111 is a difference between the first voltage V1 and the second voltage V2 (i.e., ΔV1=V1−V2), and a second driving voltage ΔV2 of the second piezoelectric layer 1112 is a difference between the second voltage V2 and the third voltage V3 (ΔV2=V2−V3), and an absolute value of both the first driving voltage ΔV1 and the second driving voltage ΔV2 is not higher than 5V.

In some embodiments of the present disclosure, by limiting the driving voltage applied to the first piezoelectric layer and the second piezoelectric layer, the speaker can be more compatible with a battery power supply capability and a power consumption of consumer electronic products such as earphones and audio glasses, making the speaker more practical.

It should be noted that, as the design of the electrodes of the sound generation unit 110 has an obvious effect on a deformation mode and a deformation degree of the sound generation unit 110, in some embodiments of the present disclosure, through the design of the electrodes, the sound generation unit 110 can deform to a greater extent to push a greater amount of air to radiate sound pressure, thereby enhancing the output sound pressure level of the sound generation unit 110. The design of the electrodes may include, but is not limited to, designing an area of an electrode-covered region, a shape of the electrode-covered region, etc.

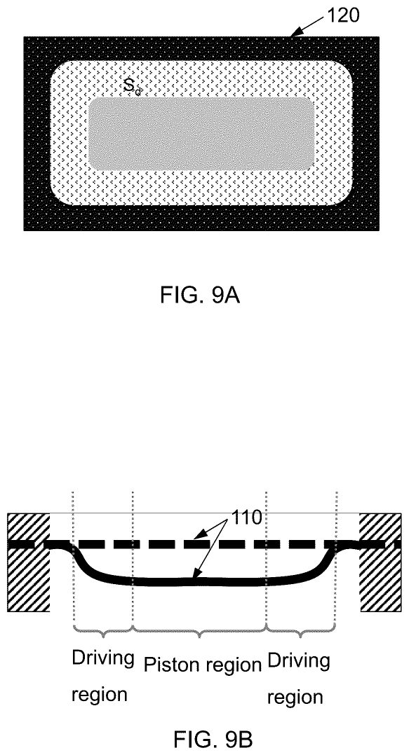

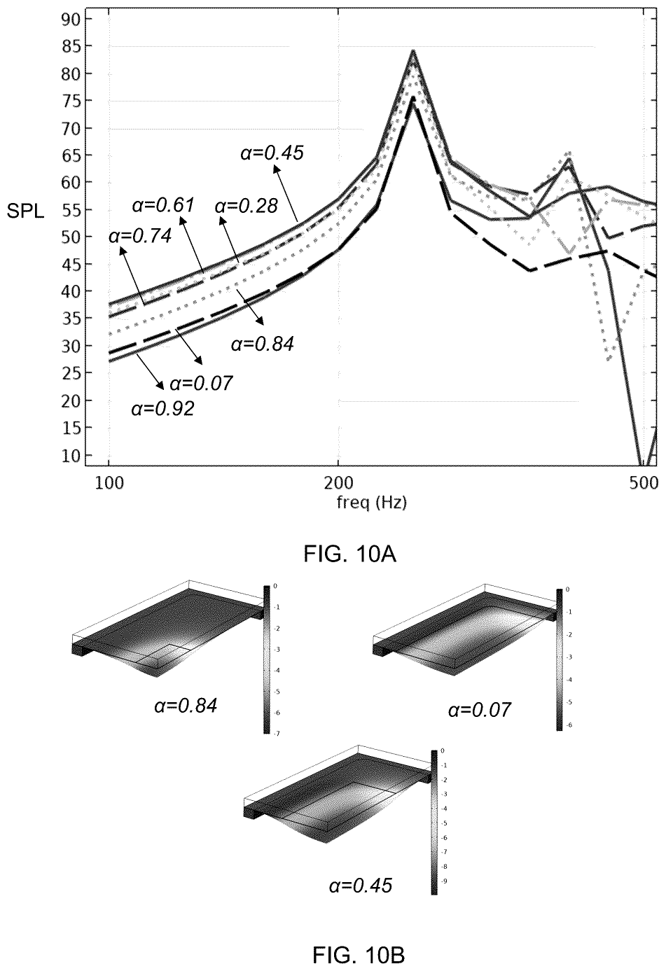

FIG. 8A is a schematic diagram illustrating a sound generation unit fully covered with electrodes according to some embodiments of the present disclosure; FIG. 8B is a schematic diagram illustrating a deformation of a sound generation unit fully covered with electrodes according to some embodiments of the present disclosure; FIG. 9A is a schematic diagram illustrating an exemplary sound generation unit partially covered with electrodes according to some embodiments of the present disclosure; FIG. 9B is a schematic diagram illustrating a deformation of a sound generation unit partially covered with electrodes according to some embodiments of the present disclosure; FIG. 10A is a graph illustrating frequency response curves corresponding to different α according to some embodiments of the present disclosure; and FIG. 10B is a local deformation cloud diagram of sound generation units corresponding to different α according to some embodiments of the present disclosure.

In some embodiments, the sound unit 110 is fully covered with the electrodes. As shown in FIGS. 8A-8B, when the sound generation unit 110 is fully covered with the electrodes, the sound generation unit 110 generates a full-region deformation when an excitation voltage is applied, and a deformation mode is a concave or convex deformation mode in and before a first-order mode.

In some embodiments, the sound unit 110 is partially covered with the electrodes.

In some embodiments, the sound unit 110 includes an electrode-covered region and a non-electrode-covered region. The electrode-covered region refers to a region on the sound generation unit 110 that is covered with the electrodes, and the non-electrode-covered region refers to a region on the sound generation unit 110 that is not covered with the electrodes.

In some embodiments, the non-electrode-covered region is located at a center of the sound generation unit 110.

As shown in FIGS. 8A-9B, Sa denotes a first area of the electrode-covered region; Sₚ denotes an overhanging area of the sound generation unit 110 (i.e., an overall area of the sound generation unit minus an area in contact with the housing), and a parameter α is defined as a ratio of the first area Sa of the electrode-covered region to the overhanging area Sₚ of the sound generation unit 110, i.e.,

$$α = \frac{{S}_{d}}{{S}_{p}} .$$

In some embodiments, when the sound generation unit 110 is partially covered with electrodes, the deformation mode includes a local concave or convex deformation mode and a local piston deformation mode in and before the first-order mode. By making the sound generation unit 110 partially covered with the electrodes, the deformation of a driving region is greater, and the deformation of the driving region is superimposed with a displacement amount of the piston region, so that an overall volume of the air being pushed is increased, thereby enhancing the output sound pressure level of the sound generation unit 110.

Specifically, as the non-electrode-covered region located at a center of the sound generation unit 110 does not deform, under the same conditions (e.g., the same voltage, the same material, etc.), the deformation generated by the driving region of an annular electrode-covered region is greater as compared to a region on the full electrode-covered region that corresponds to the driving region of the annular electrode-covered region. Combining the setting of the piston region, the overall volume of the air pushed by the sound generation unit 110 is increased, and the output sound pressure level of the sound generation unit 110 can be improved.

In some embodiments, by designing the first area Sa of the electrode-covered region, the local concave or convex deformation mode and the local piston deformation mode of the sound generation unit 110 are effectively controlled. Based on this, some embodiments of the present disclosure are illustrated in combination with parameter α.

In some embodiments, a ratio α of a first area S_{d} of the electrode-covered region to an overhanging area Sₚ of the sound generation unit 110 is in a range of 0.28-0.84.

In some embodiments, the output sound pressure level is relatively low when a is either relatively small or great. As shown in FIGS. 10A-10B, when α=0.92 or α=0.07, the output sound pressure level is significantly lower compared to when α=0.28-0.84, with a difference of more than 5 dB. This is because when α is small, i.e., the first area Sa of the electrode-covered region is small, an area of the sound generation unit 110 involved in generating the driving force is small (i.e., the area of the driving region is small). Even though the area of the piston region is great, the overall displacement is small, e.g., when α=0.07, the local deformation cloud diagram of the sound generation unit 110 shows that a maximum absolute displacement is 6 μm; when α is great, i.e., the first area S_{d} of the electrode-covered region is great, the area of the sound generation unit 11 involved in generating the driving force is great (i.e., the area of the driving region is great), but the area of the piston region is small, for example, when α=0.84, the local deformation cloud diagram of the sound generation unit 110 shows that the maximum absolute displacement is 7 μm, and although the maximum displacement is greater compared to that of α=0.07, the overall volume of air pushed is small. When α=0.45, it may be seen from the local deformation cloud diagram of the sound generation unit 110 that the maximum absolute displacement is 9 um, which is greater than the maximum absolute displacement when α=0.07 or α=0.84, and there is a large piston region, thus the overall output sound pressure level is great; when α=0.28-0.84, the output sound pressure level is higher than the output sound pressure level when α=0.92 or α=0.07 (the difference is more than 5 dB). Therefore, the parameter α is in a range of 0.28-0.84. Further, the parameter α is in a range of 0.28-0.74.

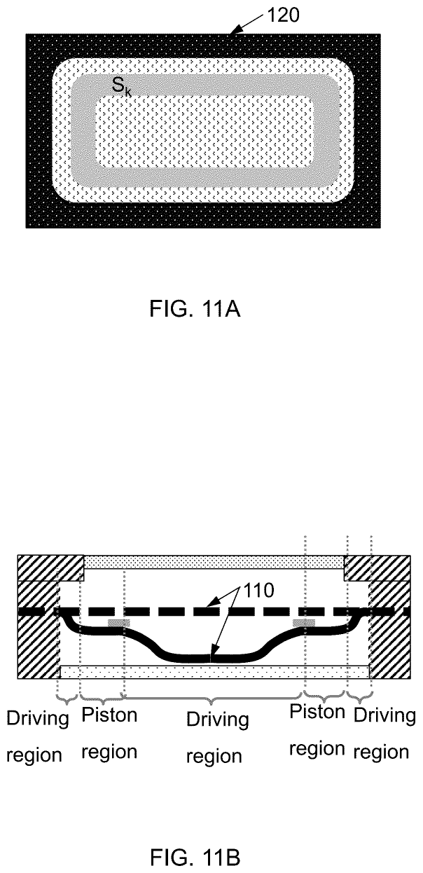

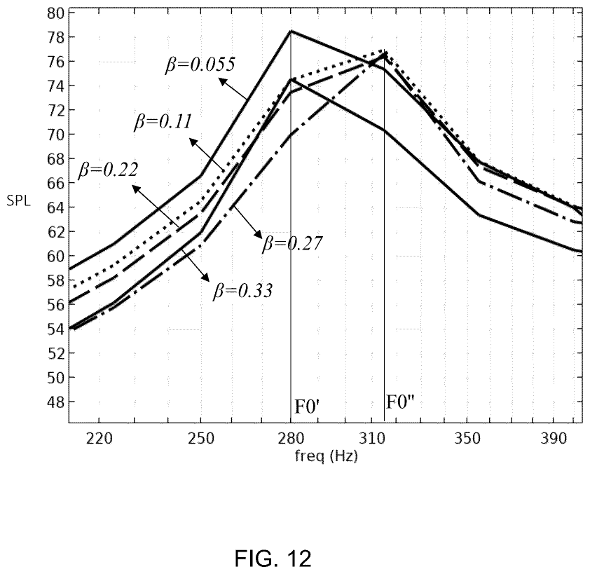

FIG. 11A is a schematic diagram illustrating an exemplary sound generation unit partially covered with dual-region electrodes according to some embodiments of the present disclosure; FIG. 11B is a schematic diagram illustrating a deformation of a sound generation unit partially covered with dual-region electrodes according to some embodiments of the present disclosure; FIG. 12 is a graph illustrating frequency response curves corresponding to different β according to some embodiments of the present disclosure.

In some embodiments, a non-electrode-covered region is a ring surrounding a center of the sound generation unit 110, that is, the sound generation unit 110 is partially covered with dual-region electrodes.

As shown in FIGS. 11A-11B, Sₖ denotes a second region of the non-electrode-covered region; Sₚ denotes an overhanging area of the sound generation unit 110 (i.e., an overall area of the sound generation unit minus an area in contact with the housing), and the parameter β is defined as a ratio of the second area Sₖ of the non-electrode-covered region to the overhanging area Sₚ of the sound generation unit 110, i.e.,

$$β = \frac{{S}_{k}}{{S}_{p}} .$$

In some embodiments, compared to a manner in which the sound generation unit 110 is partially covered with the electrodes, by designing the sound generation unit 110 to be partially covered with the dual-region electrodes, a deformation amount of the sound generation unit 110 in an original piston region is further increased, so as to regulate a deformation mode of the sound generation unit 110, which in turn regulates an acoustic effect. At this time, the non-electrode-covered region is a ring surrounding the center of the sound generation unit 110, and the two electrode-covered regions are located inside and outside the ring, respectively.

In some embodiments, for the method in which the sound generation unit 110 is partially covered with the dual-region electrodes, the design of the second region Sₖ of the non-electrode-covered region of the sound generation unit 110 is extremely important. As an area of this portion is too small, process difficulty is increased, and a higher process control precision is required. However, if the second area Sₖ of the non-electrode-covered region is too great, the portion of the sound generation unit 110 involved in generating deformation is significantly reduced, which may reduce the output sound pressure level. Therefore, the second area Sₖ of the non-electrode-covered region of the sound generation unit 110 needs to be controlled to effectively ensure the output sound pressure level of the sound generation unit 110. Based on this, some embodiments of the present disclosure will be illustrated in conjunction with the parameter β.

In some embodiments, the ratio β of the second area Sₖ of the non-electrode-covered region to the overhanging area Sₚ of the sound generation unit 110 is less than or equal to 0.27.

In some embodiments, when β is large, the output sound pressure level is significantly reduced due to the reduction in the area of the sound-emitting unit 110 involved in generating the deformation. As shown in FIG. 12, when β=0.33 or β=0.27, the output sound pressure level is significantly reduced compared to that when β≤0.22, and the difference exceeds 2 dB before the corresponding resonant frequency F0 (for example, the resonant frequency F0′ corresponding to β=0.33, and the resonant frequency F0″ corresponding to β=0.27); when β=0.27, although the output sound pressure level is significantly reduced before the corresponding resonant frequency F0 (i.e., F0″), the output sound pressure level after the corresponding resonant frequency F0 (i.e., F0″) is close to that when β≤0.22. Therefore, the parameter β is less than or equal to 0.27. Further, the parameter β is less than or equal to 0.22.

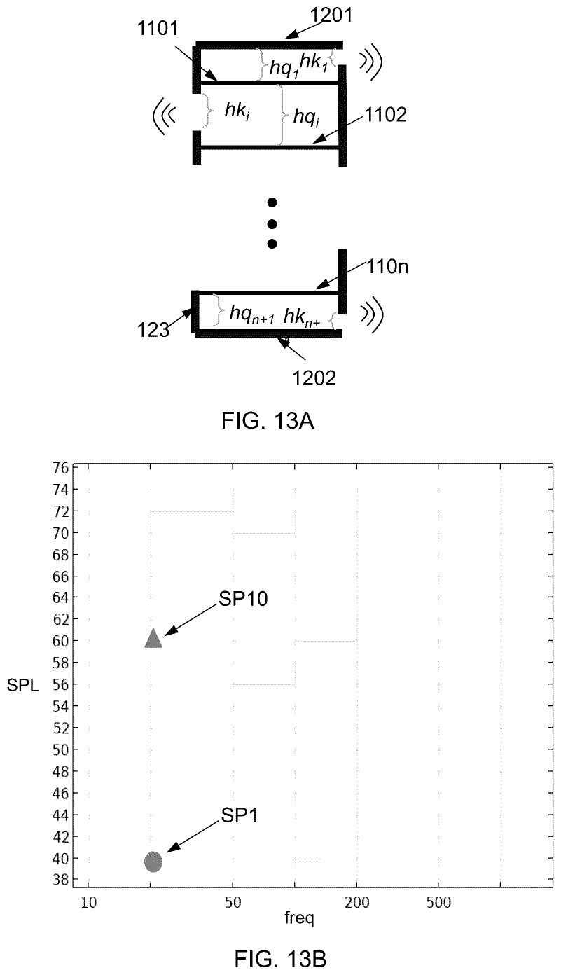

FIG. 13A is a schematic diagram illustrating a structure of a stacked (10-layer) speaker according to some embodiments of the present disclosure; and FIG. 13B is a graph illustrating frequency response curves of a stacked speaker and a single-layer speaker according to some embodiments of the present disclosure.

Some embodiments of the present disclosure take a stacked speaker including 10 layers of sound generation units 110 as an example, and compare the stacked speaker with a single-layer speaker under the same conditions (e.g., the same material, the same structural sizes, etc.). As shown in FIG. 13A, the height of the first acoustic cavity 1221 formed between the front housing 1201 and its adjacent first sound generation unit 1101 in a first direction is denoted as hq₁, and the height of the sound outlet hole 1211 coupled to the first acoustic cavity 1221 in the first direction is denoted as hk₁; a height of the third acoustic cavity 1223 formed between two adjacent sound generation units 110 (e.g., the i−1st sound generation unit and the ith sound generation unit) is denoted as hqᵢ; a height of the sound outlet hole 1211 coupled to the third acoustic cavity 1223 in the first direction is denoted as hkᵢ; a height of the second acoustic cavity 1222 formed between the rear housing 1202 and its adjacent nth sound generation unit in the first direction is denoted as hqₙ₊₁, and a height of the sound outlet hole 121 (n+1) coupled with the second acoustic cavity 1222 in the first direction is denoted as hkₙ₊₁. i is an integer greater than 1 and less than n.

As shown in FIG. 13B, SP10 denotes the stacked (10-layer) speaker; SP1 denotes the single-layer speaker. When hqᵢ=300 um, hq₁=hqₙ₊₁=150 um, hkᵢ=100 um, hkᵢ=hkₙ₊₁₌₅₀ μm, at the same frequency, the output sound pressure level of the stacked speaker SP10 is about 60 dB, while the output sound pressure level of the single-layer speaker SP1 is about 40 dB. It can be seen that the output sound pressure level of the stacked speaker SP10 is increased by about 20 dB compared to the output sound pressure level of the single-layer speaker SP1 (20 dB=20×log₁₀(10)). Further, when hqᵢ=300 um, hq₁=hqₙ₊₁=150 um, hkᵢ=100 um, hk₁=hkₙ₊₁=50 μm, the output sound pressure level of the stacked speaker does not reduce due to the small heights of the acoustic cavity 122 and the sound outlet hole 121 coupled to the acoustic cavity 122.

It can be understood that when the heights of the acoustic cavity 122 and the sound outlet hole 121 coupled to the acoustic cavity 122 are constant, while ensuring that the structural strength of the speaker 100 is not affected, the greater the width of the sound outlet hole 121 in a direction perpendicular to the first direction, i.e., the greater the area of the sound outlet hole 121, the smaller an acoustic resistance, and the greater the output sound pressure level. Thus, the heights of the acoustic cavity 122 and the acoustic outlet hole 121 coupled to the acoustic cavity 122 in the stacked speaker in the first direction is preferably hqᵢ≥300 um, hq₁>150 um, hqₙ₊₁≥150 um, hkᵢ≥100 um, hk₁≥50 um, hkₙ₊₁≥50 um.

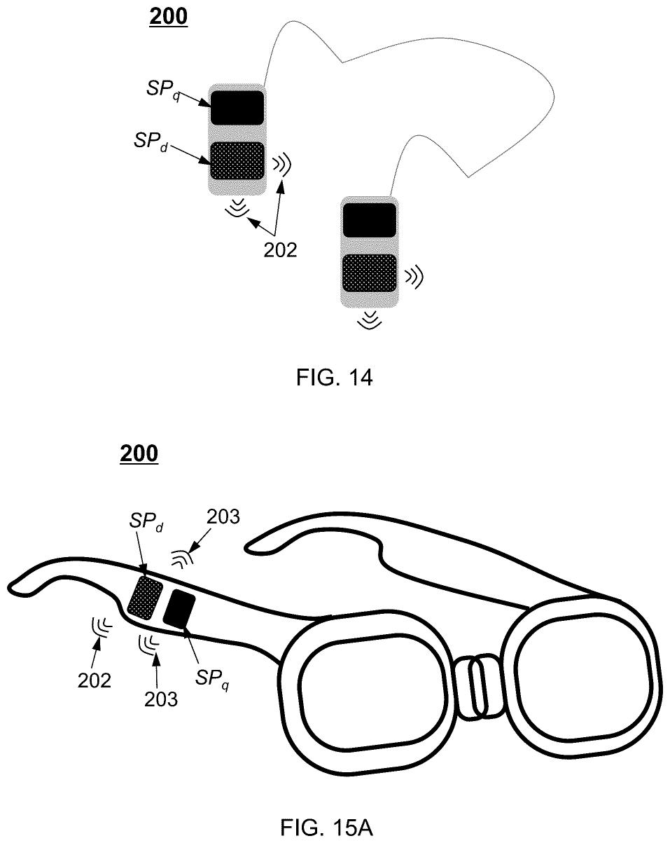

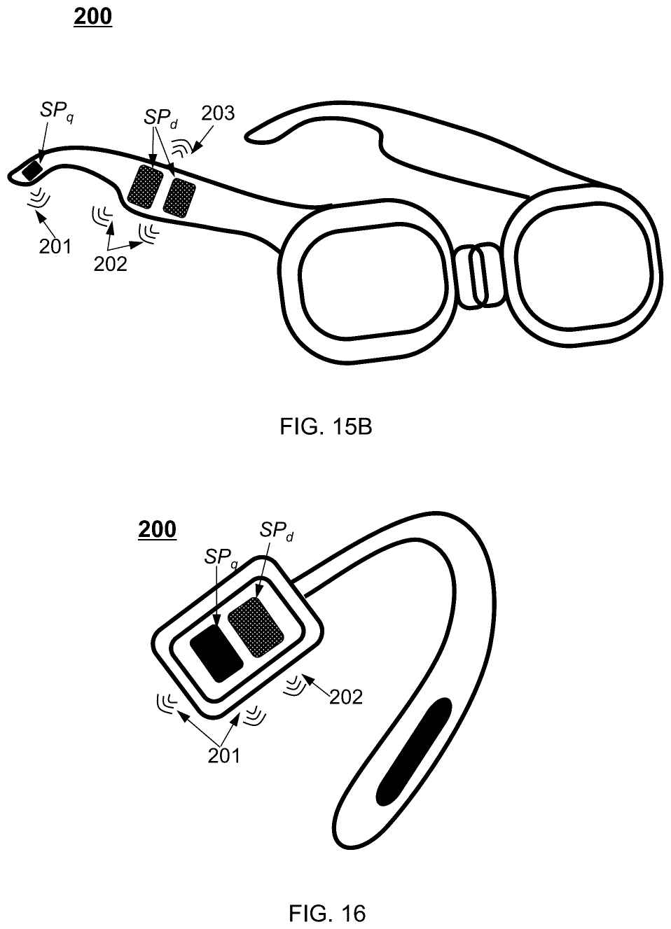

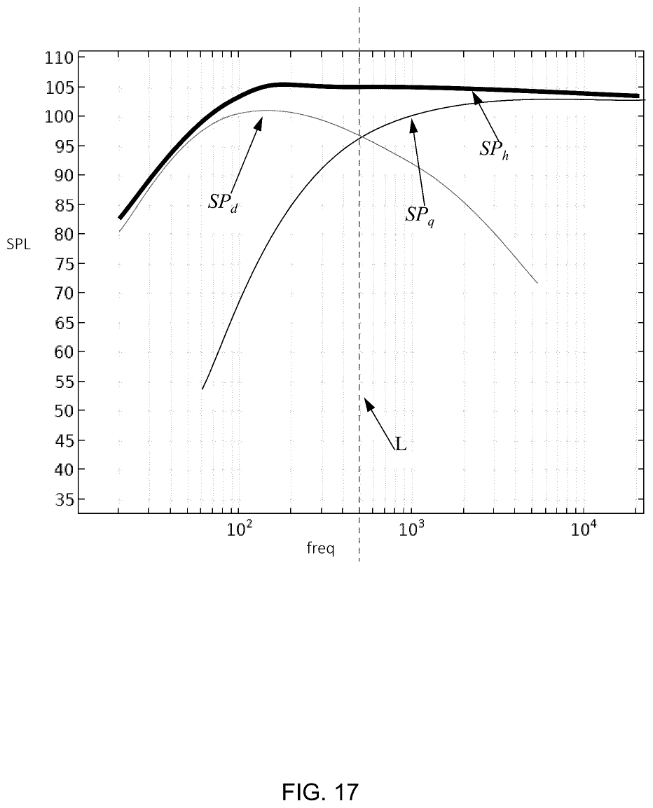

FIG. 14 is a schematic diagram illustrating an exemplary acoustic output device according to some embodiments of the present disclosure; FIG. 15A is a schematic diagram I illustrating an exemplary acoustic output device according to some other embodiments of the present disclosure; FIG. 15B is a schematic diagram II illustrating an exemplary acoustic output device according to some embodiments of the present disclosure; FIG. 16 is a schematic diagram illustrating an exemplary acoustic output device according to some other embodiments of the present disclosure, and FIG. 17 is a curve diagram illustrating a frequency response of an acoustic output device according to some embodiments of the present disclosure.

In some embodiments, the present disclosure provides the acoustic output device including: a low-frequency unit and a high-frequency unit, the low-frequency unit including the speaker 100 as described in FIGS. 1A-13B and the related contents thereof.

In some embodiments, the acoustic output device 200 includes one or more of a rear hanging earphone, an earhook earphone, an in-ear earphone, and glasses.

In some embodiments, the acoustic output device 200 includes at least one low-frequency unit and at least one high-frequency unit. As shown in FIG. 14, for an open-ear headphone, the low-frequency unit and the high-frequency unit are respectively disposed on the earphones on both sides.

As shown in FIG. 15B, for open binaural audio glasses, two low-frequency units and one high-frequency unit are respectively disposed on two temples to enhance an output sound pressure level at low frequencies.

As shown in FIG. 17, SP_{d} is a frequency response curve of a low-frequency unit, SP_{q} is a frequency response curve of a high-frequency unit, SPₕ is a frequency response curve of the acoustic output device after crossover combination, and the dashed line indicates a crossover line L (i.e., a straight line where a frequency corresponding to an intersection of SP_{d} and SP_{q} is located). In some embodiments, the intersection of the frequency response curves of the low-frequency unit and the high-frequency unit is in a range of 300 Hz-1000 Hz, i.e., the crossover line L is in a range of 300 Hz-1000 Hz.

The low-frequency unit refers to a structural unit in the acoustic output device 200 that is capable of achieving a better sound pressure level output in the low-frequency band. In some embodiments, the low-frequency unit includes, but is not limited to, an air-conduction piezoelectric stacked speaker, etc.

In some embodiments, the low-frequency unit operates in a first frequency range with the crossover line L as an upper boundary. That is, the upper boundary of the first frequency range is located in a range of 300 Hz-1000 Hz. In some embodiments, the upper boundary of the first frequency range is located in other suitable ranges. For example, the upper boundary of the first frequency range is located in a range of 300 Hz-1500 Hz, etc. In some embodiments, the first frequency range is referred to as a low-frequency band.

In some embodiments, as the air conduction piezoelectric stacked speaker is capable of outputting a greater sound pressure level in the low-frequency band, the air conduction piezoelectric stacked speaker is used in the low-frequency band to better achieve a fuller low-frequency effect.

The high-frequency unit refers to a structural unit in the acoustic output device 200 that is capable of achieving a better sound pressure level output in the high-frequency band. In some embodiments, the high-frequency unit includes an air conduction speaker and/or a bone conduction speaker.

In some embodiments, the high-frequency unit operates at least in a second frequency range with the crossover line L as the lower boundary. In some embodiments, the second frequency range is referred to as the high-frequency band. As shown in FIGS. 14-17, when the high-frequency unit is the bone conduction speaker, as the bone conduction speaker is capable of outputting a great sound pressure level in the high-frequency band and a slightly insufficient sound pressure level in the low-frequency band, to achieve the full-band sound effect, the acoustic output device 200 may combine the bone conduction speaker and the air conduction piezoelectric stacked speaker, so that the bone conduction speaker is used in the high-frequency band and the air conduction piezoelectric stacked speaker is used in the low-frequency band. Of course, in some embodiments, the bone conduction speaker operates in the low-frequency band and the high-frequency band to further enhance the low-frequency effect. At this point, the output of the air-conduction piezoelectric stacked speaker dominates in the low-frequency band.

As shown in FIGS. 14-16, the high-frequency unit of the acoustic output device 200 may be the air conduction speaker, at which point the acoustic output device may be either of a crossover design or not, i.e., the air conduction speaker (the high-frequency unit) may operate only in the high-frequency band (the second frequency range), or in the low-frequency band and the high-frequency band at the same time. At this point, in the low-frequency band, the outputs of the bone conduction speaker and the air conduction piezoelectric stacked speaker are superimposed to further enhance the low-frequency output effect.

In some embodiments, the acoustic output device 200 has a height direction parallel to the first direction and a thickness direction perpendicular to the first direction. The low-frequency unit and the high-frequency unit are disposed along the height direction, and the low-frequency unit is disposed at a lower side of the high-frequency unit; alternatively, the low-frequency unit and the high-frequency unit are disposed along the thickness direction, and the high-frequency unit is disposed on a side of the acoustic output unit 200 close to the user.

The height direction parallel to the first direction may be understood as a direction parallel to a front end surface of the acoustic output device 200 close to the user; the thickness direction perpendicular to the first direction may be understood as a direction perpendicular to the front end surface of the acoustic output device 200 close to the user.

In some embodiments of the present disclosure, by setting the high-frequency unit on the side of the acoustic output device 200 close to the user, when the high-frequency unit adopts the bone conduction speaker, it is more conducive to a transmission of sound to improve a user experience.

As shown in FIGS. 14-16, the high-frequency unit is acoustically coupled to a first sound outlet hole 201 disposed in the acoustic output device 200, and the low-frequency unit is acoustically coupled to a second sound outlet hole 202 disposed in the acoustic output device 200. The first sound outlet hole 201 and the second sound outlet hole 202 both face the user. The first sound outlet hole 201 and the second sound outlet hole 202 are the same hole or different holes.

As shown in FIG. 14, when the high-frequency unit of the acoustic output device 200 adopts the bone conduction speaker SP_{g}, there is no need to dispose the first acoustic hole 201 acoustically coupled to the high-frequency unit.

In some embodiments, the first sound outlet hole 201 and the second sound outlet hole 202 being the same hole is understood as that the first sound outlet hole 201 and the second sound outlet hole 202 are one sound outlet hole shared by the high-frequency unit and the low-frequency unit; the first sound outlet hole 201 and the second sound outlet hole 202 being different holes is understood as that the first sound outlet hole 201 and the second sound outlet hole 202 are independently disposed sound outlet holes. By independently disposing the first sound outlet hole 201 and the second sound outlet hole 202 that are acoustically coupled to the high-frequency unit and the low-frequency unit, the cavities of the high-frequency unit and the low-frequency unit may be isolated, which is conducive to improving the effect of sound transmission.

In some embodiments, the acoustic output device 200 includes a plurality of sound outlet holes. For example, the acoustic output device 200 includes a first sound outlet hole 201 acoustically coupled to the high-frequency unit, and two second sound outlet holes 202 acoustically coupled to the low-frequency unit, or, includes two first sound outlet holes 201 acoustically coupled to the high-frequency unit, and one second sound outlet hole 202 acoustically coupled to the low-frequency unit (as shown in FIG. 16). As another example, the acoustic output device 200 includes independently disposed first sound outlet holes 201 and second sound outlet holes 202 acoustically coupled to the high-frequency unit and the low-frequency unit, respectively, and also includes a sound outlet hole shared by the high-frequency unit and the low-frequency unit or two low-frequency units, which is referred to as a third sound outlet hole 203 (as shown in FIGS. 15A-15B).

Beneficial effects brought about by embodiments of the present disclosure include, but are not limited to: 1) by setting two sound generation units that are adjacent to each other and share at least one acoustic cavity to vibrate in opposite directions in at least some low-frequency bands, and in combination with the design of the sound outlet holes in some embodiments of the present disclosure, the sound pressure level output by the speaker with n sound generation units (i.e., the stacked speaker) is increased by 20×log₁₀(n) times compared to the sound pressure level output by the speaker with only one sound generation unit (i.e., the single-layer speaker); 2) as the thickness of the piezoelectric speaker is thin, by arranging a plurality of piezoelectric sound generation units at intervals in the first direction (the thickness direction), a great low-frequency output can be obtained while achieving a small size of the speaker; 3) by flexibly adjusting the count of sound generation units in the first direction, the speaker can be applied to more usage scenarios, so as to make it widely applicable and practical; (4) by setting at least one mass block on the sound generation unit, the resonant frequency F0 of the speaker can be adjusted, so as to enable the speaker to better satisfy the different requirements of different users and different usage scenarios; (5) by limiting the voltages applied to the first piezoelectric layer and the second piezoelectric layer, the speaker can be more compatible with a battery power supply capability and a power consumption of consumer electronic products such as earphones and audio glasses, making the speaker more practical.

It should be noted that different embodiments may produce different beneficial effects. In different embodiments, the beneficial effects that are produced may be any one or a combination of the above, or any other beneficial effects that are obtained.

The basic concepts have been described above, and it is apparent to those skilled in the art that the foregoing detailed disclosure serves only as an example and does not constitute a limitation of the present disclosure. While not expressly stated herein, various modifications, improvements, and amendments may be made to the present disclosure by those skilled in the art. Those types of modifications, improvements, and amendments are suggested in the present disclosure, so those types of modifications, improvements, and amendments remain within the spirit and scope of the exemplary embodiments of the present disclosure.

Also, the present disclosure uses specific words to describe embodiments thereof. Such as “an embodiment,” “one embodiment,” and/or “some embodiments” means a feature, structure, or characteristic associated with at least one embodiment of the present disclosure. Accordingly, it should be emphasized and noted that “one embodiment” or “an embodiment” or “an alternative embodiment” in different places in the present disclosure do not necessarily refer to the same embodiment. In addition, certain features, structures, or characteristics in one or more embodiments of the present disclosure may be suitably combined.

Additionally, unless expressly stated in the claims, the order of the processing elements and sequences, the use of numerical letters, or the use of other names as described in the present disclosure are not intended to limit the order of the processes and methods of the present disclosure. While some embodiments of the present disclosure that are currently considered useful are discussed in the foregoing disclosure by way of various examples, it should be appreciated that such examples serve only illustrative purposes and that additional claims are not limited to the disclosed embodiments. Rather, the claims are intended to cover all amendments and equivalent combinations that are consistent with the substance and scope of the embodiments of the present disclosure. For example, although the implementation of various components described above may be embodied in a hardware device, it may also be implemented as a software only solution, e.g., an installation on an existing server or mobile device.

Similarly, it should be noted that to simplify the presentation of the disclosure of the present disclosure, and thereby aid in the understanding of one or more embodiments of the present disclosure, the foregoing descriptions of embodiments of the present disclosure sometimes group multiple features together in a single embodiment, accompanying drawings, or a description thereof. However, this method of disclosure does not imply that the objects of the present disclosure require more features than those mentioned in the claims. Rather, claimed subject matter may lie in less than all features of a single foregoing disclosed embodiment.

Some embodiments use numbers describing the number of components, attributes, and it should be understood that such numbers used in the description of embodiments are modified in some examples by the modifiers “approximately,” “nearly,” or “substantially.” Unless otherwise noted, the terms “approximately,” “nearly,” or “substantially” indicates that a ±20% variation in the stated number is allowed. Correspondingly, in some embodiments, the numerical parameters used in the present disclosure and claims are approximations, which change depending on the desired characteristics of individual embodiments. In some embodiments, the numerical parameters should consider the specified number of valid digits and use a general digit retention method. While the numerical domains and parameters used to confirm the breadth of their ranges in some embodiments of the present disclosure are approximations, in specific embodiments such values are set to be as precise as possible within a feasible range.

Finally, it should be understood that the embodiments described in the present disclosure are only used to illustrate the principles of the embodiments of the present disclosure. Other deformations may also fall within the scope of the present disclosure. As such, alternative configurations of embodiments of the present disclosure may be viewed as consistent with the teachings of the present disclosure as an example, not as a limitation. Correspondingly, the embodiments of the present disclosure are not limited to the embodiments expressly presented and described herein.

1. A speaker comprising:
a plurality of sound generation units spaced apart along a first direction, the plurality of sound generation units being configured to vibrate in the first direction;
a housing configured to accommodate and support the plurality of sound generation units, the housing being disposed with a plurality of sound outlet holes, and the housing encloses a plurality of acoustic cavities with the plurality of sound generation units, each of the plurality of acoustic cavities being acoustically coupled to at least one sound outlet hole on the housing, wherein
under excitation signals, two adjacent sound generation units, which are among the plurality of sound generation units and sharing at least one acoustic cavity in the plurality of acoustic cavities, vibrate in opposite directions in at least some low frequency bands.

2. The speaker of claim 1, wherein the housing includes a plurality of fixing rings, each fixing ring of the plurality of fixing rings fixing one sound generation unit of the plurality of sound generation units, and two acoustic outlet holes are disposed on a periphery of the fixing ring, wherein the two acoustic outlet holes are respectively coupled to the acoustic cavities at two opposite sides of the sound generation unit.

3. The speaker of claim 2, wherein the housing includes a front housing and a rear housing, the front housing and its adjacent sound generation unit form a first acoustic cavity, the rear housing and its adjacent sound generation unit form a second acoustic cavity, a third acoustic cavity is formed between two adjacent sound generation units, and a thickness of the first acoustic cavity or a thickness of the second acoustic cavity in the first direction is less than a thickness of the third acoustic cavity in the first direction.

4. The speaker of claim 3, wherein heights of the first acoustic cavity and the second acoustic cavity in the first direction are greater than or equal to 150 um, a height of the third acoustic cavity in the first direction is greater than or equal to 300 um, heights of the sound outlet holes corresponding to the first acoustic cavity and the second acoustic cavity in the first direction are greater than or equal to 50 um, and a height of a sound outlet hole corresponding to the third acoustic cavity in the first direction is greater than or equal to 100 um.

5. The speaker of claim 2, wherein the housing includes a front housing and a rear housing, at least two electrodes are disposed on the each fixing ring, and the at least two electrodes on the each fixing ring are respectively connected to the front housing or the rear housing through a corresponding conductive electrode.

6. (canceled)

7. The speaker of claim 1, wherein a sound generation unit of the plurality of sound generation units includes a flexible piezoelectric material, and a Young's modulus of the flexible piezoelectric material is in a range of 1.5 GPa-9 GPa.

8. The speaker of claim 1, wherein a sound generation unit of the plurality of sound generation units includes a first piezoelectric layer and a second piezoelectric layer arranged in the first direction, and a neutral layer of the sound generation unit is located between the first piezoelectric layer and the second piezoelectric layer.

9. The speaker of claim 8, wherein the sound generation unit further includes a first electrode layer, a second electrode layer, and a third electrode layer, and in the first direction, the first electrode layer, the first piezoelectric layer, the second electrode layer, the second piezoelectric layer, and the third electrode layer are arranged in sequence; and
the first piezoelectric layer and the second piezoelectric layer are configured such that deformation directions of the first piezoelectric layer and the second piezoelectric layer are opposite to each other.

10. The speaker of claim 9, wherein a first driving voltage of the first piezoelectric layer is a difference between a first voltage of the first electrode layer and a second voltage of the second electrode layer, a second driving voltage of the second piezoelectric layer is a difference between the second voltage and a third voltage of the third electrode layer, and an absolute value of the first driving voltage and an absolute value of the second driving voltage are both not higher than 5 V.

11. The speaker of claim 1, wherein a sound generation unit of the plurality of sound generation units is disposed with one or more mass blocks.

12. The speaker of claim 1, wherein a sound generation unit of the plurality of sound generation units includes an electrode-covered region and a non-electrode-covered region.

13. The speaker of claim 12, wherein the non-electrode covered region is located at a center of the sound generation unit, and a ratio of a first area of the electrode-covered region to an overhanging area of the sound generation unit is in a range of 0.28-0.84.

14. The speaker of claim 12, wherein the non-electrode-covered region is an annulus encircling a center of the sound generation unit, and a ratio of a second area of the non-electrode-covered region to an overhanging area of the sound generation unit is less than or equal to 0.27.

15. An acoustic output device, comprising: a low-frequency unit and a high-frequency unit, the low-frequency unit including a speaker of claim 1, wherein
an intersection of frequency response curves of the low-frequency unit and the high-frequency unit is in a range of 300 Hz-1000 Hz.

16. The acoustic output device of claim 15, wherein the high-frequency unit includes an air conduction speaker and/or a bone conduction speaker.

17. The acoustic output device of claim 15, wherein the high-frequency unit operates at least in a frequency range whose lower boundary is the intersection.

18. The acoustic output device of claim 15, wherein the acoustic output device has a height direction parallel to the first direction and a thickness direction perpendicular to the first direction, wherein
the low-frequency unit and the high-frequency unit are disposed along the height direction, and the low-frequency unit is disposed on a lower side of the high-frequency unit; or
the low-frequency unit and the high-frequency unit are disposed along the thickness direction, and the high-frequency unit is disposed on a side of the acoustic output device close to a user.

19. The acoustic output device of claim 18, wherein the high-frequency unit is acoustically coupled to a first sound outlet hole disposed on the acoustic output device, the low-frequency unit is acoustically coupled to a second sound outlet hole disposed on the acoustic output device, and the first sound outlet hole and the second sound outlet hole face the user, wherein
the first sound outlet hole and the second sound outlet hole are the same hole or different holes.

20. The acoustic output device of claim 15, wherein the acoustic output device includes at least one of a rear hanging earphone, an earhook earphone, an in-ear earphone, and eyeglasses.

21. The speaker of claim 3, wherein a size of a sound outlet hole corresponding to the first acoustic cavity or the second acoustic cavity is smaller than a size of a sound outlet hole corresponding to the third acoustic cavity.
